(19) United States
(12) Patent Application Publication
(10) Pub. No.: US 2024/0183569 A1
(43) Pub. Date: Jun. 6, 2024

(54) AIR PASSAGE TYPE SILENCER

(71) Applicant: FUJIFILM Corporation, Tokyo (JP)

(72) Inventors: Yoshihiro SUGAWARA, Ashigarakami-gun (JP); Shogo YAMAZOE, Ashigarakami-gun (JP); Shinya HAKUTA, Ashigarakami-gun (JP); Yuichiro ITAI, Ashigarakami-gun (JP); Tomohiro TAKAHASHI, Ashigarakami-gun (JP)

(73) Assignee: FUJIFILM Corporation, Tokyo (JP)

(21) Appl. No.: 18/439,877

(22) Filed: Feb. 13, 2024

Related U.S. Application Data
(63) Continuation of application No. PCT/JP22/29607, filed on Aug. 2, 2022.

(30) Foreign Application Priority Data
Aug. 27, 2021 (JP) 2021-138772
Mar. 24, 2022 (JP) 2022-047867
Jul. 21, 2022 (JP) 2022-116660

(51) Int. Cl. F24F 13/02; F24F 13/24

(52) U.S. Cl. CPC F24F 13/0209; F24F 2013/242

(57) ABSTRACT

To provide an air passage type silencer that can suppress generation of a wind noise, that has a high sound attenuation effect in a low-frequency band, and that has high air passage performance. The air passage type silencer includes an inlet-side ventilation pipe, an expansion portion that communicates with the inlet-side ventilation pipe and of which a cross-sectional area is larger than a cross-sectional area of the inlet-side ventilation pipe, an outlet-side ventilation pipe that communicates with the expansion portion and of which a cross-sectional area is smaller than a cross-sectional area of the expansion portion, an opening portion structure of which a cross-sectional area gradually decreases from an inside of the expansion portion toward a connection portion between the expansion portion and the outlet-side ventilation pipe, a rear surface space that is surrounded by the opening portion structure, a side surface of the expansion portion that is on an outlet-side ventilation pipe side, and a peripheral surface of the expansion portion, and a porous sound absorbing material that is disposed at least in an opening portion of the rear surface space.

### CROSS-REFERENCE TO RELATED APPLICATIONS

This application is a Continuation of PCT International Application No. PCT/JP2022/029607 filed on Aug. 2, 2022, which claims priority under 35 U.S.C. § 119(a) to Japanese Patent Application No. 2021-138772 filed on Aug. 27, 2021, Japanese Patent Application No. 2022-047867 filed on Mar. 24, 2022, and Japanese Patent Application No. 2022-116660 filed on Jul. 21, 2022. The above applications are hereby expressly incorporated by reference, in their entirety, into the present application.

### BACKGROUND OF THE INVENTION

### 1. Field of the Invention

The present invention relates to an air passage type silencer.

### 2. Description of the Related Art

As a silencer that attenuates a noise from a gas supply source or the like at a ventilation path intermediate position of a ventilation pipe through which a gas is transported, an expansion type silencer that is installed at a ventilation path intermediate position and that includes an expansion portion of which the cross-sectional area is larger than that of the ventilation pipe is known.

In the case of an air passage type silencer, there is a problem that a wind noise is generated and sound attenuation performance is deteriorated in a case where the wind speed of wind passing through the inside of the air passage type silencer is made high. With regard to this, an inlet pipe communicating with an expansion portion and a tail pipe are made tapered in order to achieve sound attenuation while suppressing generation of a wind noise.

For example, described in JP1986-184808Y (JP-S61-184808Y) is an expansive type silencer obtained by inserting an inlet pipe and a tail pipe (an outlet pipe) into an expansion portion, the inlet pipe and the tail pipe inserted into the expansion portion are formed to be tapered in the expansion portion, bell mouths are formed at opening portions of the inlet pipe and the tail pipe, and the bell mouths are provided to face each other.

### SUMMARY OF THE INVENTION

In a case where an expansion type silencer is used for noise reduction in a device including a ventilation pipe like various devices including a blower (a fan), the expansion type silencer is limited in size since the expansion type silencer is to be installed in the device. However, in a case where the expansion type silencer is reduced in size, there is a problem that low-frequency sound attenuation performance is deteriorated.

In addition, in a case where a tail pipe is formed to be tapered in an expansion portion, a space (hereinafter, will be referred to as a rear surface space) surrounded by the tail pipe and a housing of the expansion portion is formed. In a case where wind passes through the inside of an air passage type silencer, wind may flow into such a rear surface space and an air passage rate may decrease due to airflow turbulence such as backflow of the wind. In addition, the airflow turbulence may cause a vortex and a pressure fluctuation, which may increase a wind noise.

An object of the present invention is to provide an air passage type silencer that can suppress generation of a wind noise, that has a high sound attenuation effect in a low-frequency band, and that has high air passage performance while solving the above-described problem of the related art.

In order to solve the above-described problem, the present invention has the following configurations.
[1] An air passage type silencer including:
an inlet-side ventilation pipe;
an expansion portion that communicates with the inlet-side ventilation pipe and of which a cross-sectional area is larger than a cross-sectional area of the inlet-side ventilation pipe;
an outlet-side ventilation pipe that communicates with the expansion portion and of which a cross-sectional area is smaller than a cross-sectional area of the expansion portion;
an opening portion structure of which a cross-sectional area gradually decreases from an inside of the expansion portion toward a connection portion between the expansion portion and the outlet-side ventilation pipe;
a rear surface space that is surrounded by the opening portion structure, a side surface of the expansion portion that is on an outlet-side ventilation pipe side, and a peripheral surface of the expansion portion; and
a porous sound absorbing material that is disposed at least in an opening portion of the rear surface space.
[2] The air passage type silencer described in [1],
in which f₁×(1-0.2)<F<fc is satisfied, where F is a resonance frequency in the rear surface space in a state where the porous sound absorbing material is not disposed, f₁ is a first resonance frequency of the air passage type silencer in the state where the porous sound absorbing material is not disposed, and fc is a cutoff frequency determined by a cross-sectional area of an opening of the outlet-side ventilation pipe.
[3] The air passage type silencer described in [1] or [2],
in which a cross-sectional shape of the opening portion structure that is perpendicular to a central axis of the outlet-side ventilation pipe is a quadrangular shape,
a distance between one pair of sides facing each other gradually decreases from the inside of the expansion portion toward the connection portion between the expansion portion and the outlet-side ventilation pipe, and
a distance between the other pair of sides facing each other is constant.
[4] The air passage type silencer described in [1] or [2],
in which the opening portion structure has a structure in which two plate-shaped members face each other and a distance between the two plate-shaped members gradually decreases from the inside of the expansion portion toward the connection portion between the expansion portion and the outlet-side ventilation pipe.
[5] The air passage type silencer described in any one of [1] to [4],
in which a cross-sectional shape of the expansion portion that is perpendicular to a central axis of the outlet-side ventilation pipe is a rectangular shape.
[6] The air passage type silencer described in any one of [1] to [5],
in which a central axis of the outlet-side ventilation pipe and a central axis of the inlet-side ventilation pipe are on one straight line.
[7] The air passage type silencer described in any one of [1] to [6],
in which the porous sound absorbing material is disposed on a region from a side surface of the expansion portion that is on an inlet-side ventilation pipe side to a side surface on the outlet-side ventilation pipe side.
[8] The air passage type silencer described in any one of [1] to [7],
in which a central axis of the outlet-side ventilation pipe is offset from a center of the side surface of the expansion portion.
[9] The air passage type silencer described in any one of [1] to [8],
in which the opening portion structure includes a region in which a wall thickness decreases toward an inlet-side ventilation pipe side.
[10] The air passage type silencer described in any one of [1] to [9],
in which the opening portion structure is attachable and detachable with respect to the expansion portion.

According to the present invention, it is possible to provide an air passage type silencer that can suppress generation of a wind noise, that has a high sound attenuation effect in a low-frequency band, and that has high air passage performance.

### BRIEF DESCRIPTION OF THE DRAWINGS

FIG. 1 is a cross-sectional view conceptually showing an example of an air passage type silencer according to an aspect of the present invention.

FIG. 2 is a cross-sectional view taken along line B-B in FIG. 1.

FIG. 3 is a cross-sectional view conceptually showing another example of the air passage type silencer according to the aspect of the present invention.

FIG. 4 is a cross-sectional view conceptually showing another example of an opening portion structure.

FIG. 5 is a cross-sectional view conceptually showing another example of the air passage type silencer according to the aspect of the present invention.

FIG. 6 is a cross-sectional view conceptually showing another example of the air passage type silencer according to the aspect of the present invention.

FIG. 7 is a cross-sectional view conceptually showing another example of the air passage type silencer according to the aspect of the present invention.

FIG. 8 is a cross-sectional view conceptually showing another example of the opening portion structure.

FIG. 9 is a cross-sectional view conceptually showing another example of the opening portion structure.

FIG. 10 is a cross-sectional view conceptually showing another example of the opening portion structure.

FIG. 11 is a cross-sectional view conceptually showing another example of the opening portion structure.

FIG. 12 is a cross-sectional view conceptually showing another example of the opening portion structure.

FIG. 13 is a cross-sectional view conceptually showing another example of the opening portion structure.

FIG. 14 is a cross-sectional view conceptually showing another example of the opening portion structure.

FIG. 15 is a cross-sectional view conceptually showing another example of the opening portion structure.

FIG. 16 is a cross-sectional view conceptually showing another example of the opening portion structure.

FIG. 17 is a view schematically showing a configuration of an air passage type silencer of Comparative Example 1.

FIG. 18 is a view schematically showing a configuration of an air passage type silencer of Comparative Example 2.

FIG. 19 is a view schematically showing a configuration of an air passage type silencer of Comparative Example 3.

FIG. 20 is a view for description about a sound attenuation amount measuring method.

FIG. 21 is a graph showing a relationship between the frequency and the sound pressure level.

FIG. 22 is a graph showing a relationship between the frequency and the sound pressure level.

FIG. 23 is a graph showing a relationship between the frequency and the sound attenuation amount.

FIG. 24 is a graph showing a relationship between the frequency and the sound attenuation amount.

FIG. 25 is a graph showing a relationship between the frequency and the sound attenuation amount.

FIG. 26 is a graph for comparison between total sound attenuation amounts.

FIG. 27 is a graph showing a relationship between the frequency and the transmission loss.

FIG. 28 is a graph showing a relationship between the frequency and the transmission loss.

FIG. 29 is a view for description about a wind speed measuring method.

FIG. 30 is a graph for comparison between wind speeds.

FIG. 31 is a cross-sectional view conceptually showing another example of the air passage type silencer according to the aspect of the present invention.

FIG. 32 is a cross-sectional view conceptually showing another example of the air passage type silencer according to the aspect of the present invention.

FIG. 33 is a cross-sectional view conceptually showing another example of the air passage type silencer according to the aspect of the present invention.

FIG. 34 is a cross-sectional view conceptually showing another example of the air passage type silencer according to the aspect of the present invention.

FIG. 35 is a cross-sectional view conceptually showing another example of the air passage type silencer according to the aspect of the present invention.

FIG. 36 is a cross-sectional view conceptually showing another example of the air passage type silencer according to the aspect of the present invention.

FIG. 37 is a cross-sectional view conceptually showing another example of the air passage type silencer according to the aspect of the present invention.

FIG. 38 is a cross-sectional view conceptually showing another example of the air passage type silencer according to the aspect of the present invention.

FIG. 39 is a cross-sectional view conceptually showing another example of the air passage type silencer according to the aspect of the present invention.

FIG. 40 is a view showing the air passage type silencer in FIG. 39 from which an opening portion structure has been removed.

FIG. 41 is a front view of the opening portion structure that the air passage type silencer shown in FIG. 39 includes.

FIG. 42 is a cross-sectional view conceptually showing another example of the air passage type silencer according to the aspect of the present invention.

FIG. 43 is a cross-sectional view conceptually showing another example of the air passage type silencer according to the aspect of the present invention.

FIG. 44 shows front views conceptually showing other examples of the air passage type silencer according to the aspect of the present invention.

### DESCRIPTION OF THE PREFERRED EMBODIMENTS

Hereinafter, the present invention will be specifically described.

Although configuration requirements to be described below may be described based on a representative embodiment of the present invention, the present invention is not limited to such an embodiment.

Note that, in the present specification, a numerical range represented using “to” means a range including numerical values described before and after the preposition “to” as a lower limit value and an upper limit value.

In addition, in the present specification, “perpendicular” and “parallel” include a range of errors accepted in the technical field to which the present invention belongs. For example, “being perpendicular” or “being parallel” means being in a range of less than ±10° or the like with respect to being strictly perpendicular in the strict sense or being parallel in the strict sense and the error with respect to being strictly perpendicular in the strict sense or being parallel in the strict sense is preferably 5° or less, and more preferably 3º or less.

In the present specification, the meanings of terms such as “the same” and “identical” may include a range of errors generally accepted in the technical field.

### [Air Passage Type Silencer]

An air passage type silencer according to an embodiment of the present invention is an air passage type silencer including
an inlet-side ventilation pipe;
an expansion portion that communicates with the inlet-side ventilation pipe and of which a cross-sectional area is larger than a cross-sectional area of the inlet-side ventilation pipe;
an outlet-side ventilation pipe that communicates with the expansion portion and of which a cross-sectional area is smaller than a cross-sectional area of the expansion portion;
an opening portion structure of which a cross-sectional area gradually decreases from an inside of the expansion portion toward a connection portion between the expansion portion and the outlet-side ventilation pipe;
a rear surface space that is surrounded by the opening portion structure, a side surface of the expansion portion that is on an outlet-side ventilation pipe side, and a peripheral surface of the expansion portion; and
a porous sound absorbing material that is disposed at least in an opening portion of the rear surface space.

The configuration of the air passage type silencer according to the embodiment of the present invention will be described with reference to the drawings.

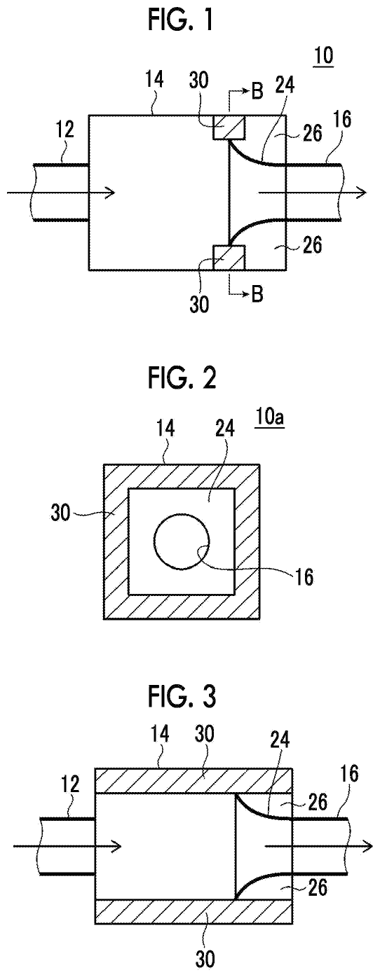

FIG. 1 is a conceptual cross-sectional view showing an example of an embodiment of the air passage type silencer according to the embodiment of the present invention. FIG. 2 is a cross-sectional view taken along a line B-B of FIG. 1.

As shown in FIG. 1, an air passage type silencer 10 includes a tubular inlet-side ventilation pipe 12, an expansion portion 14 connected to one opening edge surface of the inlet-side ventilation pipe 12, a tubular outlet-side ventilation pipe 16 that is connected to an edge surface of the expansion portion 14 on a side opposite to a surface on the inlet-side ventilation pipe 12 side, an opening portion structure 24, and a porous sound absorbing material 30.

The inlet-side ventilation pipe 12 is a tubular member through which a gas that flows into the inlet-side ventilation pipe 12 through one opening edge surface is transported to the expansion portion 14 connected to the other opening edge surface.

The outlet-side ventilation pipe 16 is a tubular member through which a gas that flows into the outlet-side ventilation pipe 16 through one opening edge surface connected to the expansion portion 14 is transported to the other opening edge surface.

The cross-sectional shapes of the inlet-side ventilation pipe 12 and the outlet-side ventilation pipe 16 (hereinafter, collectively referred to as ventilation pipes) may be various shapes such as a circular shape, a rectangular shape, and a triangular shape. In addition, the cross-sectional shape of a ventilation pipe may not be constant in an axial direction along a central axis (hereinafter, may be simply referred to as a “central axis”) of the ventilation pipe. For example, the diameter of the ventilation pipe may change in the axial direction.

The inlet-side ventilation pipe 12 and the outlet-side ventilation pipe 16 may have the same cross-sectional shape and cross-sectional area, or may have different shapes and/or cross-sectional areas. In addition, in an example shown in FIG. 1, the inlet-side ventilation pipe 12 and the outlet-side ventilation pipe 16 are disposed such that central axes thereof coincide with each other (that is, the inlet-side ventilation pipe 12 and the outlet-side ventilation pipe 16 are disposed to be present on one straight line). However, the present invention is not limited thereto and the central axis of the inlet-side ventilation pipe 12 and the central axis of the outlet-side ventilation pipe 16 may be offset from each other.

In the following description, a direction in which the inlet-side ventilation pipe 12, the expansion portion 14, and the outlet-side ventilation pipe 16 are arranged will be referred to as a flow path direction in some cases.

The expansion portion 14 is disposed between the inlet-side ventilation pipe 12 and the outlet-side ventilation pipe 16 and transports, to the outlet-side ventilation pipe 16, a gas that flows into the expansion portion 14 from the inlet-side ventilation pipe 12. In an example shown in FIGS. 1 and 2, the expansion portion 14 has a hollow approximately rectangular parallelepiped shape, the inlet-side ventilation pipe 12 is connected to one side surface of the expansion portion 14, and the outlet-side ventilation pipe 16 is connected to a side surface facing the one side surface.

The cross-sectional area of the expansion portion 14 that is perpendicular to the flow path direction is larger than the cross-sectional area of the inlet-side ventilation pipe 12 and is larger than the cross-sectional area of the outlet-side ventilation pipe 16. That is, for example, in a case where the cross-sectional shapes of the inlet-side ventilation pipe 12, the outlet-side ventilation pipe 16, and the expansion portion 14 are circular, the diameter of the cross-section of the expansion portion 14 is larger than the diameters of the inlet-side ventilation pipe 12 and the outlet-side ventilation pipe 16.

The cross-sectional shape of the expansion portion 14 that is perpendicular to the flow path direction may be various shapes such as a circular shape, a rectangular shape, and a triangular shape. In addition, the cross-sectional shape of the expansion portion 14 may not be constant in an axial direction along a central axis of the expansion portion 14. For example, the diameter of the expansion portion 14 may change in the axial direction. In the example shown in FIG. 2, the cross-sectional shape of the expansion portion is approximately square.

The opening portion structure 24 is disposed at the position of connection between the expansion portion 14 and the outlet-side ventilation pipe 16.

The opening portion structure 24 is a tapered tubular member that is disposed to be in contact with a connection portion with respect to the outlet-side ventilation pipe 16 in the expansion portion 14 and of which the opening area gradually decreases from the inlet-side ventilation pipe 12 toward the outlet-side ventilation pipe 16.

In an example shown in FIG. 2, the cross-sectional shape of the outlet-side ventilation pipe 16 that is perpendicular to the central axis is circular. In addition, the shape and the area of an edge surface of the opening portion structure 24 that is on the outlet-side ventilation pipe 16 side approximately coincide with the cross-sectional shape and the cross-sectional area of the outlet-side ventilation pipe 16. Meanwhile, an edge surface of the opening portion structure 24 that is on the inlet-side ventilation pipe 12 side has an approximately square shape and of which the area is larger than the area of the edge surface on the outlet-side ventilation pipe 16 side.

The edge surface of the opening portion structure 24 that is on the inlet-side ventilation pipe 12 side does not come into contact with an inner peripheral surface of the expansion portion 14. Therefore, a rear surface space 26 that is surrounded by the opening portion structure 24, a side surface of the expansion portion 14 that is on the outlet-side ventilation pipe 16 side, and the inner peripheral surface of the expansion portion 14 and that is open on the inlet-side ventilation pipe 12 side is formed.

As shown in FIG. 1, the porous sound absorbing material 30 is disposed in an opening portion of the rear surface space 26. That is, the porous sound absorbing material 30 is disposed at a position where the porous sound absorbing material 30 comes into contact with the edge surface of the opening portion structure 24 that is on the inlet-side ventilation pipe 12 side.

As shown in FIG. 2, the porous sound absorbing material 30 has an approximately square shape as seen in the flow path direction and includes an approximately square opening. The porous sound absorbing material 30 is disposed along the inner peripheral surface of the expansion portion 14. In addition, in the example shown in FIG. 1, the length of the porous sound absorbing material 30 in the flow path direction is shorter than the length of the expansion portion 14 and is a length from an intermediate position between the inlet-side ventilation pipe 12 of the expansion portion 14 and the opening portion of the rear surface space 26 to an intermediate position in the rear surface space 26. In addition, the thickness of the porous sound absorbing material 30 in a direction perpendicular to the flow path direction is approximately equal to the width of the opening portion of the rear surface space 26.

The porous sound absorbing material 30 is disposed in the expansion portion 14 to absorb and attenuate a sound.

As described above, in the case of an air passage type silencer including an expansion portion, there is a problem that a wind noise is generated and sound attenuation performance is deteriorated in a case where the wind speed of wind passing through the inside of the air passage type silencer is made high. With regard to this, an outlet-side ventilation pipe communicating with the expansion portion is made tapered in order to achieve sound attenuation while suppressing generation of a wind noise. In addition, the tapered outlet-side ventilation pipe is disposed in the expansion portion so that air passage properties are improved. However, in a case where the tapered outlet-side ventilation pipe is disposed in the expansion portion, a rear surface space surrounded by the outlet-side ventilation pipe and a housing of the expansion portion is formed. Accordingly, in a case where wind passes through the inside of the silencer (the expansion portion), the wind may flow into the rear surface space and an effect of improving an air passage rate may not be sufficiently achieved due to airflow turbulence such as backflow of the wind. In addition, the airflow turbulence may cause a vortex and a pressure fluctuation, which may generate a wind noise. In addition, in a case where the air passage type silencer including the expansion portion is to be installed in various devices, the air passage type silencer is limited in size depending on the device. However, in a case where an expansion type silencer is reduced in size, there is a problem that low-frequency sound attenuation performance is deteriorated.

With regard to this, the air passage type silencer according to the embodiment of the present invention has a configuration in which the opening portion structure having a tapered shape is provided at the connection portion between the expansion portion and the outlet-side ventilation pipe and the porous sound absorbing material is disposed in the opening portion of the rear surface space surrounded by the opening portion structure and the expansion portion. In the rear surface space, resonance is caused by vibration of air due to a tapered three-dimensional structure and thus low-frequency resonance can be realized with a smaller size than air-column resonance which is resonance attributable to a linear structure. At this time, since a particle velocity is made high at the opening portion of the rear surface space due to the resonance, a sound absorbing effect can be exerted at a wider band of frequencies and sound attenuation performance can be improved in a case where the porous sound absorbing material is disposed at such a position. Therefore, even in a case where an expansion type silencer is reduced in size, low-frequency sound attenuation performance can be improved.

In addition, the porous sound absorbing material is disposed in the opening portion of the rear surface space and thus wind is less likely to flow into the rear surface space. Therefore, airflow turbulence such as backflow of the wind can be suppressed and a decrease in air passage rate as an expansion type silencer can be suppressed.

In addition, since the porous sound absorbing material is disposed in the opening portion of the rear surface space, a vortex and a pressure fluctuation caused by airflow turbulence can be suppressed and a decrease in soundproof performance caused by generation of a wind noise can be suppressed.

In addition, in the air passage type silencer according to the embodiment of the present invention, the rear surface space is formed between the opening portion structure and the expansion portion. The rear surface space acts as a resonator in which the action of a Helmholtz resonator is mixed and of which the resonance frequency is made lower than that of a general air-column resonator since the size of the opening portion communicating with the expansion portion is small, so that a sound attenuation effect in a low-frequency band can be enhanced.

Here, in the example shown in FIG. 1, the porous sound absorbing material 30 is disposed in the vicinity of the position of the opening portion of the rear surface space 26 in the flow path direction. However, the present invention is not limited thereto and as in an example shown in FIG. 3, the porous sound absorbing material 30 may be disposed, in the flow path direction, throughout a region from a side surface of the expansion portion 14 that is on the inlet-side ventilation pipe 12 side to a side surface that is on the outlet-side ventilation pipe 16 side. Since the porous sound absorbing material 30 is disposed over the entire expansion portion 14 in the flow path direction, airflow turbulence in the expansion portion 14 can be more suitably suppressed and a decrease in air passage rate can be suppressed.

In addition, in FIG. 3, the porous sound absorbing material 30 is disposed in a portion of the rear surface space 26. However, the present invention is not limited thereto and the entire rear surface space 26 may be filled with the porous sound absorbing material 30.

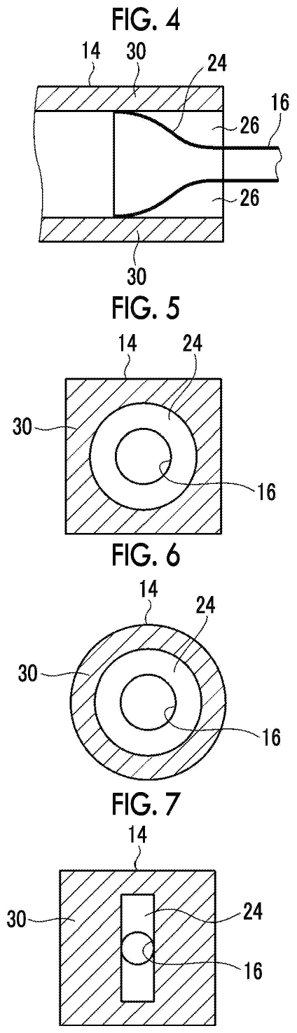

In addition, in the example shown in FIG. 1, the cross-sectional shape of the opening portion structure 24 in a cross section parallel to the flow path direction (a central axis direction of the outlet-side ventilation pipe 16) is a so-called trumpet-like shape that is convex toward a central axis side. However, the present invention is not limited thereto. For example, the cross-sectional shape of the opening portion structure 24 in the cross section parallel to the flow path direction may be a linear shape. Alternatively, as in an example shown in FIG. 4, the cross-sectional shape of the opening portion structure 24 in the cross section parallel to the flow path direction may be partially concave toward the central axis side. Alternatively, for example, the cross-sectional shape of the opening portion structure 24 in the cross section parallel to the flow path direction may be a shape of which the diameter increases stepwise with a portion of which the diameter monotonically increases along the central axis, a portion of which the diameter is constant, and a portion of which the diameter monotonically increases disposed in this order.

In addition, in the example shown in FIG. 2, the porous sound absorbing material 30 is disposed over the entire expansion portion 14 in a circumferential direction as seen in the flow path direction. However, the present invention is not limited thereto and the porous sound absorbing material 30 may be disposed on at least a portion of the expansion portion 14 in the circumferential direction. Since the porous sound absorbing material 30 is disposed over the entire expansion portion 14 in the circumferential direction, airflow turbulence in the expansion portion 14 can be more suitably suppressed, a decrease in air passage rate can be suppressed, and a sound absorbing effect can be enhanced since the area of the porous sound absorbing material as seen in the flow path direction is large.

In addition, in the example shown in FIG. 2, the shape of the expansion portion 14 as seen in the flow path direction is an approximately square shape, the shape of the edge surface of the opening portion structure 24 that is on the inlet-side ventilation pipe 12 side is an approximately square shape, and the shape of the porous sound absorbing material 30 as seen in the flow path direction is an approximately square shape including an approximately square opening. However, the present invention is not limited thereto.

For example, as in an example shown in FIG. 5, the shape of the expansion portion 14 as seen in the flow path direction may be an approximately square shape, the shape of the edge surface of the opening portion structure 24 that is on the inlet-side ventilation pipe 12 side may be an approximately circular shape, and the shape of the porous sound absorbing material 30 as seen in the flow path direction may be an approximately square shape including an approximately circular opening.

Alternatively, as in an example shown in FIG. 6, the shape of the expansion portion 14 as seen in the flow path direction may be an approximately circular shape, the shape of the edge surface of the opening portion structure 24 that is on the inlet-side ventilation pipe 12 side may be an approximately circular shape, and the shape of the porous sound absorbing material 30 as seen in the flow path direction may be an approximately circular shape including an approximately circular opening.

It is preferable that the cross-sectional shape of the expansion portion 14 and the cross-sectional shape of the opening portion structure 24 (the shape of the edge surface on the inlet-side ventilation pipe 12 side) are similar to each other.

In addition, in the examples shown in FIGS. 2, 5, and 6, the shape of the edge surface of the opening portion structure 24 that is on the inlet-side ventilation pipe 12 side is a square or circular shape of which the diameter (the diameter of an inscribed circle in the case of a polygonal shape such as a square shape) decreases from the inlet-side ventilation pipe 12 side toward the outlet-side ventilation pipe 16 side. However, the present invention is not limited thereto. For example, the opening portion structure may be configured such that the cross-sectional shape thereof perpendicular to the central axis of the outlet-side ventilation pipe is a quadrangular shape, a distance between one pair of sides facing each other gradually decreases from the inside of the expansion portion toward the connection portion between the expansion portion and the outlet-side ventilation pipe, and a distance between the other pair of sides facing each other is constant.

For example, in an example shown in FIG. 7, the cross-sectional shape (a shape as seen in a direction perpendicular to the paper plane of FIG. 7) of the opening portion structure 24 that is perpendicular to the central axis of the outlet-side ventilation pipe 16 is a quadrangular shape, a distance between sides facing each other in a right-left direction in FIG. 7 is constant, and a distance between sides facing each other in a vertical direction gradually decreases from the inside of the expansion portion 14 toward the connection portion between the expansion portion 14 and the outlet-side ventilation pipe 16 (from the inlet-side ventilation pipe 12 side toward the outlet-side ventilation pipe 16 side). In other words, the opening portion structure 24 shown in FIG. 7 consists of two plate-shaped portions that face each other to be parallel with each other and each of which has an approximately trapezoidal shape (a trapezoidal shape of which legs (sides facing each other that are not an upper base and a lower base) are curved) and two plate-shaped portions that are disposed at positions corresponding to the legs of the trapezoidal shapes between the two plate-shaped portions. Since the opening portion structure is formed in a flat shape as described above, it is possible to increase the volume of the porous sound absorbing material disposed in the opening portion of the rear surface space and to enhance the sound absorbing effect.

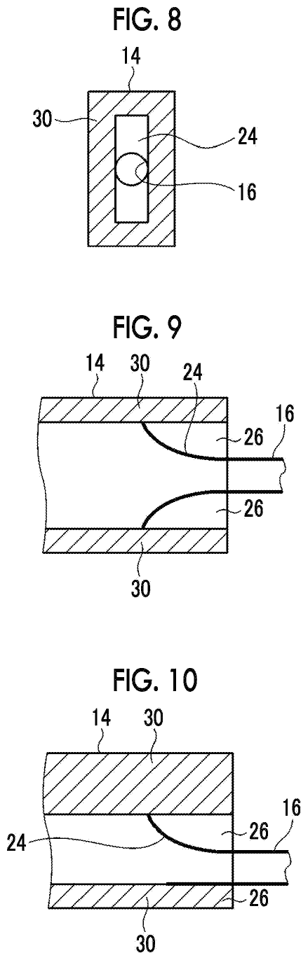

In addition, in a case where the opening portion structure 24 has a flat shape, the cross-sectional shape of the expansion portion 14 that is perpendicular to the flow path direction may be a rectangular shape as shown in FIG. 8. That is, the cross-sectional shape of the expansion portion 14 and the shape of the edge surface of the opening portion structure 24 that is on the inlet-side ventilation pipe 12 side may be similar to each other. Since the cross-sectional shape of the expansion portion 14 is rectangular, it is possible to reduce the thickness of the expansion portion 14 and to reduce the thickness of the air passage type silencer.

In addition, although the opening portion structure has a tubular shape in each of the above-described examples, the present invention is not limited thereto. The opening portion structure may be a structure in which two plate-shaped members face each other and a distance between the two plate-shaped members gradually decreases from the inside of the expansion portion toward the connection portion between the expansion portion and the outlet-side ventilation pipe (from the inlet-side ventilation pipe side toward the outlet-side ventilation pipe side).

The opening portion structure 24 shown in FIG. 9 includes two curved plate-shaped members, the two plate-shaped members are disposed to face each other without being parallel with each other, and a distance between the two plate-shaped members gradually decreases from the inlet-side ventilation pipe 12 side toward the outlet-side ventilation pipe 16 side. In addition, the opening portion structure 24 shown in FIG. 9 is open in a direction perpendicular to the paper plane of FIG. 9.

In a case where the opening portion structure 24 consists of the two plate-shaped members as in an example shown in FIG. 9, it is preferable that the porous sound absorbing material 30 is disposed to be in contact with side surfaces of the plate-shaped members as in the above-described example shown in FIG. 7. Accordingly, the area of the porous sound absorbing material 30 exposed to a flow path increases, so that the sound absorbing effect can be enhanced.

In addition, in a case where the opening portion structure 24 consists of two plate-shaped members as in the example shown in FIG. 9, the cross-sectional shape of the expansion portion 14 that is perpendicular to the flow path direction may be a rectangular shape as in an example shown in FIG. 8. In the example shown in FIG. 8, two plate-shaped members are arranged in a longitudinal direction along a long side of a cross section of the expansion portion 14.

In addition, in the example shown in FIGS. 1 and 2 and the like, the central axis of the outlet-side ventilation pipe coincides with the center of a side surface of the expansion portion. However, the central axis of the outlet-side ventilation pipe may be offset from the center of the side surface of the expansion portion.

For example, in an example shown in FIG. 10, the outlet-side ventilation pipe 16 is connected to a position that is offset from the center of the side surface of the expansion portion 14 in a downward direction in the drawing. In addition, since the outlet-side ventilation pipe 16 is connected to the position that is offset from the center of the side surface of the expansion portion 14, the opening portion structure 24 is also disposed at a position that is offset from the center of the side surface of the expansion portion 14. Note that FIG. 10 is a cross-sectional view parallel to the flow path direction.

In the example shown in FIG. 10, the opening portion structure 24 includes two plate-shaped members that approximately face each other, the plate-shaped member that is on a side (a lower side in FIG. 10) close to a housing of the expansion portion 14 is disposed to be parallel with the central axis of the outlet-side ventilation pipe 16, and the other plate-shaped member is disposed not to be parallel with the central axis of the outlet-side ventilation pipe 16. That is, the two plate-shaped members are disposed to face each other without being parallel with each other, and a distance between the two plate-shaped members gradually decreases from the inlet-side ventilation pipe 12 side toward the outlet-side ventilation pipe 16 side. In addition, the opening portion structure 24 shown in FIG. 10 is open in a direction perpendicular to the paper plane of FIG. 10. In addition, in the example shown in FIG. 10, the two plate-shaped members are integrally formed on the outlet-side ventilation pipe 16 side. In addition, as seen from the left side of FIG. 10, each plate-shaped member is curved to be concave toward the central axis side.

In addition, the opening portion structure may be the curved plate-shaped member only which is one of the plate-shaped members shown in FIG. 10. For example, an opening portion structure that has a configuration in which one side is a wall or a porous sound absorbing material and the other side is a curved plate-shaped member so that the size thereof gradually increases may also be adopted.

As described above, the opening portion structure may be configured not to be closed in a cross section at an end portion on the inlet-side ventilation pipe side.

Since the outlet-side ventilation pipe and the opening portion structure are disposed at positions offset from the center of the side surface of the expansion portion, a distance between the edge surface of the opening portion structure that is on the inlet-side ventilation pipe side and an interior wall of the expansion portion changes depending on the position and the size of the opening portion of the rear surface space differs depending on the position. Accordingly, the resonance frequency in the rear surface space differs depending on the position and thus a sound attenuation target frequency range can be lowered and widened. In addition, the air passage type silencer can be installed in accordance with spatial restrictions inside a device in which the air passage type silencer is installed.

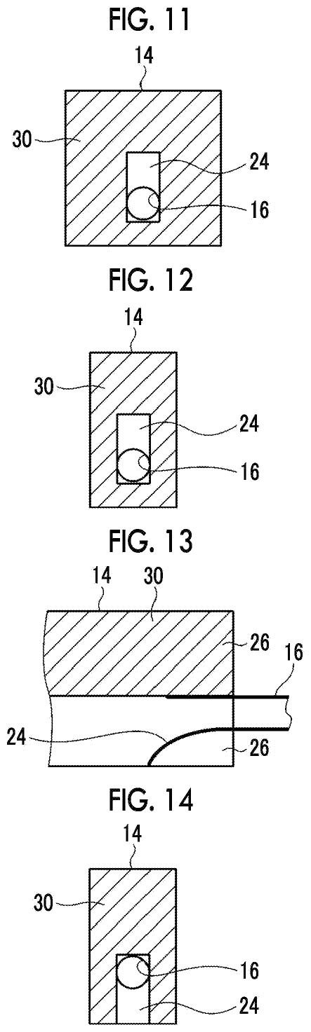

In addition, even in a case where the outlet-side ventilation pipe and the opening portion structure are disposed at positions offset from the center of the side surface of the expansion portion as shown in FIG. 10, the shape of the expansion portion as seen in the flow path direction may be an approximately square shape as shown in FIG. 11 or may be an approximately rectangular shape as shown in FIG. 12. Note that FIGS. 11 and 12 are cross-sectional views perpendicular to the flow path direction.

In the example shown in FIG. 10, the opening portion structure 24 includes the two plate-shaped members that approximately face each other, the plate-shaped member that is on a side close to the housing of the expansion portion 14 is disposed to be parallel with the central axis of the outlet-side ventilation pipe 16, and the other plate-shaped member is disposed not to be parallel with the central axis of the outlet-side ventilation pipe 16. However, the present invention is not limited thereto. As in an example shown in FIGS. 13 and 14, a configuration in which the opening portion structure 24 includes two plate-shaped members that approximately face each other, the plate-shaped member that is on a side far from the housing of the expansion portion 14 is disposed to be parallel with the central axis of the outlet-side ventilation pipe 16, and the other plate-shaped member that is on a side close to the housing is disposed not to be parallel with the central axis of the outlet-side ventilation pipe 16 may also be adopted. FIG. 13 is a cross-sectional view parallel to the flow path direction and FIG. 14 is a cross-sectional view perpendicular to the flow path direction.

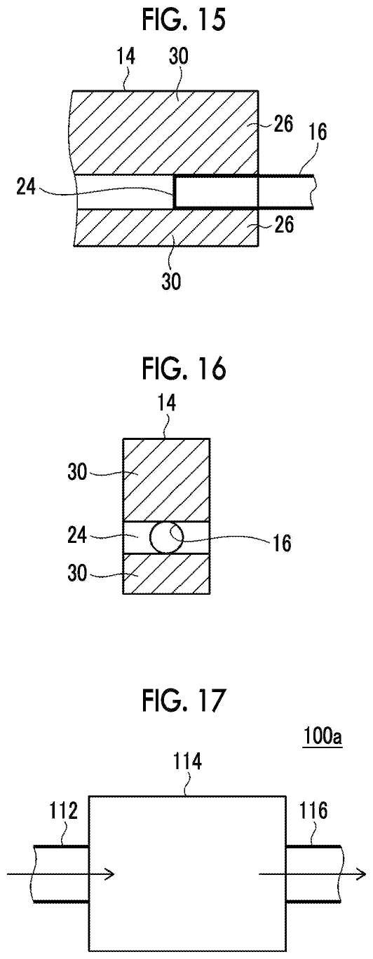

In addition, in the example shown in FIGS. 13 and 14, the two plate-shaped members are arranged in a longitudinal direction along a long side of a cross section of the expansion portion 14. However, the present invention is not limited thereto. As in an example shown in FIGS. 15 and 16, a configuration in which two plate-shaped members are arranged in a longitudinal direction along a short side of a cross section of the expansion portion 14 may also be adopted. FIG. 15 is a cross-sectional view parallel to the flow path direction and FIG. 16 is a cross-sectional view perpendicular to the flow path direction.

In addition, as shown in FIG. 31, a configuration in which the porous sound absorbing material 30 is disposed to be in contact with the opening portion structure 24 in the expansion portion 14 of which the cross-sectional shape is rectangular and a space 14a is formed on a rear surface side (a side opposite to the opening portion structure 24) of the porous sound absorbing material 30 may also be adopted, for example. In the case of such a configuration, since it is difficult for wind flowing through the air passage type silencer to pass through the porous sound absorbing material 30, the flow path of the wind leads from the porous sound absorbing material 30 to the opening portion structure 24 smoothly, so that a wind noise is less likely to be generated. With this configuration, the amount of use of the porous sound absorbing material 30 can be reduced in comparison with a case where the porous sound absorbing material 30 is disposed throughout the inside of the expansion portion 14.

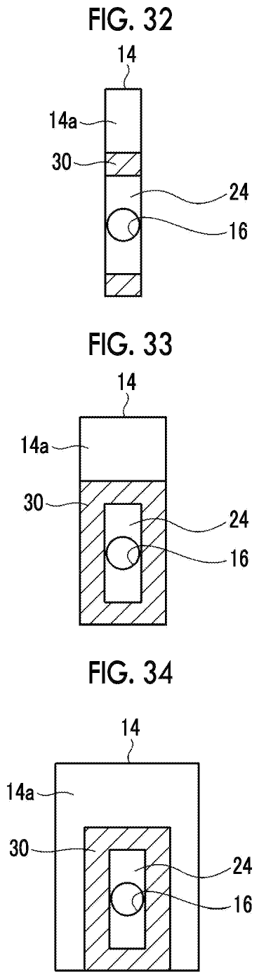

In addition, a plurality of examples of shapes of an example shown in FIG. 31 as seen in the flow path direction are shown in FIGS. 32 to 34.

In an example shown in FIG. 32, the width of the expansion portion 14 in a right-left direction (a direction perpendicular to the paper plane of FIG. 31) in FIG. 32 is approximately equal to the diameter of the outlet-side ventilation pipe 16 and side surfaces of the two plate-shaped members constituting the opening portion structure 24 are approximately in contact with two wall surfaces that are present in a width direction (the right-left direction) of the expansion portion 14. In the case of such a configuration, the porous sound absorbing materials 30 are disposed above and below the opening portion structure 24 in FIG. 32.

In an example shown in FIG. 33, the width of the expansion portion 14 in a right-left direction (the direction perpendicular to the paper plane of FIG. 31) in FIG. 33 is larger than the diameter of the outlet-side ventilation pipe 16. In the case of such a configuration, the porous sound absorbing material 30 is disposed to surround the opening portion structure 24 and the side surfaces of the two plate-shaped members constituting the opening portion structure 24 are approximately in contact with the porous sound absorbing material 30 disposed on right and left sides. In addition, in the example shown in FIG. 33, a space between the opening portion structure 24 and two wall surfaces of the expansion portion 14 in the width direction (the right-left direction) is filled with the porous sound absorbing material 30.

In an example shown in FIG. 34, the width of the expansion portion 14 in the right-left direction (the direction perpendicular to the paper plane of FIG. 31) in FIG. 34 is larger than the diameter of the outlet-side ventilation pipe 16. In the case of the configuration in FIG. 34, the porous sound absorbing material 30 is disposed to surround the opening portion structure 24 and the side surfaces of the two plate-shaped members constituting the opening portion structure 24 are approximately in contact with the porous sound absorbing material 30 disposed on right and left sides. In addition, in the example shown in FIG. 34, the space 14a is formed on a side opposite to the opening portion structure 24 with respect to the porous sound absorbing material 30 in the width direction (the right-left direction).

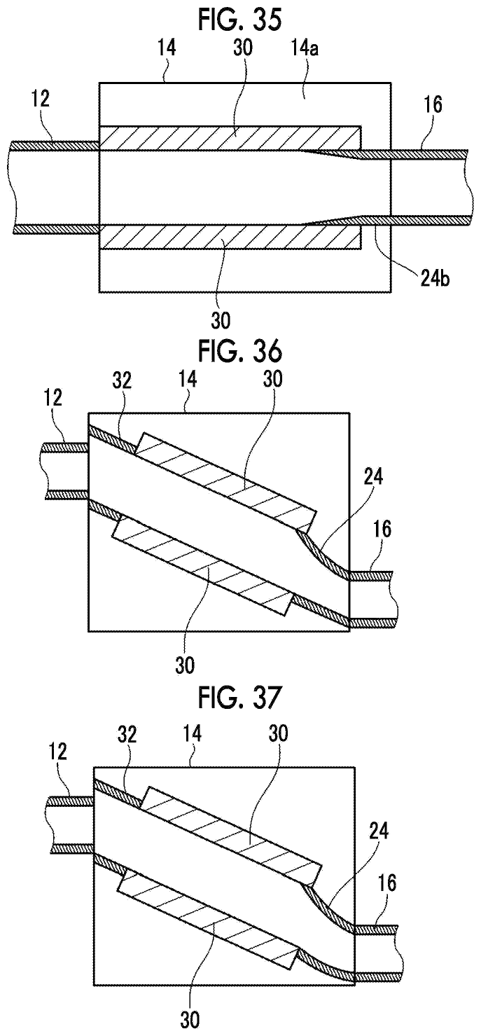

In addition, the opening portion structure may not have a cross-sectional shape of which the size increases as in the above-described examples and a configuration in which the wall thickness of an end portion of an opening portion structure 24b gradually decreases as in an example shown in FIG. 35 may also be adopted. That is, the opening portion structure 24b has the same cross-sectional shape as the outlet-side ventilation pipe 16 and the wall thickness of an end portion on the inlet-side ventilation pipe 12 side gradually decreases toward the inlet-side ventilation pipe 12 side. The opening portion structure 24b and the outlet-side ventilation pipe 16 may be integrally formed with each other.

For example, in a case where the inner diameter of the outlet-side ventilation pipe 16 is 30 mm and the wall thickness thereof is 2 mm in the example shown in FIG. 35, a ratio of the area of the inner diameter (a diameter of 34 mm) of a distal end portion (on the inlet-side ventilation pipe 12 side) to the area of the inner diameter of a proximal end portion (on the outlet-side ventilation pipe 16 side) of the opening portion structure 24b is 1.28 and in a case where the wall thickness is 3 mm, a ratio of the area of the inner diameter of the distal end portion to the area of the inner diameter of the proximal end portion is 1.44. In addition, the opening portion structure 24b is a structure in which the cross-sectional area gradually changes. In a case where the opening portion structure 24b has a configuration including a region in which the wall thickness gradually decreases as in the example shown in FIG. 35, a change in cross-sectional area can be made gentle and the volume of a wind noise can be reduced. In addition, although a configuration in which the inside of the opening portion structure is gradually widened with the outer shape thereof kept constant is desirable, a configuration in which a distal end portion is sharpened may also be adopted.

In addition, the opening portion structure 24b may include a constant-wall-thickness region having a certain length and a region on a distal end side in which the wall thickness gradually decreases as in the example shown in FIG. 35 and may have a configuration including only a region in which the wall thickness gradually decreases.

In addition, a configuration in which the wall thickness of an end portion of the opening portion structure having a cross-sectional shape (an outer shape) of which the size increases as in the examples shown in FIGS. 1 to 16 gradually decreases may also be adopted.

Here, in the present invention, the lengths and the diameters of the inlet-side ventilation pipe and the outlet-side ventilation pipe, the size of the expansion portion, the length of the opening portion structure, the size and the shape of the edge surface on the inlet-side ventilation pipe side, the size of the rear surface space, the area of the opening portion of the rear surface space, the size and the flow resistance of the porous sound absorbing material, and the like may be set as appropriate in accordance with the sound attenuation performance (a sound attenuation frequency and a sound attenuation amount), the air passage rate, and the like that the air passage type silencer is required to have.

In addition, in the present invention, it is preferable that f₁×(1-0.2)<F<fc is satisfied, where F is a resonance frequency in the rear surface space in a state where the porous sound absorbing material is not disposed, f₁ is a first resonance frequency of the air passage type silencer in a state where the porous sound absorbing material is not disposed, and fc is a cutoff frequency determined by the cross-sectional area of an opening of the outlet-side ventilation pipe.

Here, a first resonance frequency f₁ of the air passage type silencer in a state where the porous sound absorbing material is not disposed is lowest-frequency resonance of resonance generated in the flow path direction with an entrance of the air passage type silencer as a sound pressure node and is a frequency satisfying f₁=2×(sound velocity)/L, where L is the length of the air passage type silencer.

In addition, a cutoff frequency fc is a frequency determined by the cross-sectional dimension of the flow path and at a frequency equal to or lower than fc, a sound wave to be propagated can be made close to a plane sound wave and is easily propagated.

Generally, fc satisfies fc=0.586×(sound velocity)/(diameter of circle) in a case where the cross-sectional shape of the outlet-side ventilation pipe on an outlet side is a circle and satisfies fc=0.5×(sound velocity)/(long side of rectangle) in a case where the cross-sectional shape of the outlet-side ventilation pipe on the outlet side is a rectangle.

In a general expansion type air passage type silencer, resonance with an entrance as a sound pressure node amplifies a transmitted sound wave and deteriorates the sound attenuation performance. In many cases, improvement in sound attenuation performance with respect to a first resonance frequency, which is the lowest frequency thereof, causes a problem.

It is possible to improve low-frequency sound attenuation performance by lowering a resonance frequency F in the rear surface space. However, on a higher frequency side than the resonance frequency F in the rear surface space, the sound attenuation performance tends to be deteriorated and the sound attenuation performance is significantly deteriorated in a region where such a deterioration frequency and a deterioration frequency due to first resonance are close to each other. Therefore, it is preferable that the resonance frequency F is equal to or larger than 0.8 times the first resonance frequency f₁ of the air passage type silencer. In addition, it is more preferable that the resonance frequency F is equal to or larger than 0.9 times the first resonance frequency f₁ of the air passage type silencer.

In addition, at a frequency higher than the cutoff frequency fc of the outlet-side ventilation pipe, it is difficult for sound to be propagated through the ventilation pipe and sound is attenuated at a portion corresponding to the ventilation pipe even in a case where there is no silencer. Therefore, the resonance frequency F in the rear surface space may be set to be equal to or lower than the cutoff frequency fc of the outlet-side ventilation pipe.

The resonance frequency F in the rear surface space can be measured through a transmission loss evaluation with vertical incidence acoustic transmission loss measurement based on ASTM E 2611 or a transmission loss evaluation with an acoustic simulation (not including fluid calculation) in which a finite element method is used.

In addition, in each of the above-described examples, the air passage type silencer has a configuration in which the opening portion structure is provided on the outlet-side ventilation pipe side only. However, the present invention is not limited thereto and an opening portion structure may be provided at a connection portion between the expansion portion and the inlet-side ventilation pipe in the expansion portion. The opening portion structure on the inlet-side ventilation pipe side has the same configuration as the opening portion structure disposed on the outlet-side ventilation pipe side except that the opening portion structure on the inlet-side ventilation pipe side is disposed in such a direction that the cross-sectional area thereof gradually increases from the inlet-side ventilation pipe side toward the outlet-side ventilation pipe side.

In addition, in the example shown in FIG. 1 or the like, the central axes of the inlet-side ventilation pipe 12 and the outlet-side ventilation pipe 16 are disposed on the same straight line. However, the present invention is not limited thereto. For example, as in examples shown in FIGS. 36 and 37, the central axes of the inlet-side ventilation pipe 12 and the outlet-side ventilation pipe 16 may not be disposed on the same straight line. Even in the case of such a configuration, the opening portion structure can be disposed.

In an example shown in FIG. 36, at a connection portion between the expansion portion 14 and the inlet-side ventilation pipe 12, a bend ventilation pipe 32 provided to bend the flow path from a flow direction of the inlet-side ventilation pipe 12 to a direction connecting the inlet-side ventilation pipe 12 and the outlet-side ventilation pipe 16 to each other is disposed. The opening portion structure 24 is disposed at the connection portion between the expansion portion 14 and the outlet-side ventilation pipe 16. The opening portion structure 24 has a configuration in which two plate-shaped members are disposed to face each other and the two plate-shaped members are disposed such that the flow path is bent from the direction connecting the inlet-side ventilation pipe 12 and the outlet-side ventilation pipe 16 to each other to a flow direction of the outlet-side ventilation pipe 16. In addition, one of the plate-shaped members of the opening portion structure 24 is curved in a direction away from the other of the plate-shaped members in a direction from the outlet-side ventilation pipe 16 to the inlet-side ventilation pipe 12. Accordingly, the opening portion structure 24 has a configuration in which the cross-sectional area of the opening portion structure 24 gradually changes. In the example shown in FIG. 36, the opening portion structure 24 has a configuration in which one of the plate-shaped members is curved. However, a configuration in which both of the plate-shaped members are curved may also be adopted.

In an example shown in FIG. 37, the opening portion structure 24 has a configuration in which two plate-shaped members are disposed to face each other and the two plate-shaped members are curved. Although the two plate-shaped members are curved in the same direction, the curvature radiuses thereof are different from each other, and the cross-sectional area gradually changes.

In addition, even in the case of a configuration in which the central axes of the inlet-side ventilation pipe 12 and the outlet-side ventilation pipe 16 are not on the same straight line, a configuration in which the opening portion structure has a region in which the wall thickness gradually decreases so that the cross-sectional area gradually changes may also be adopted.

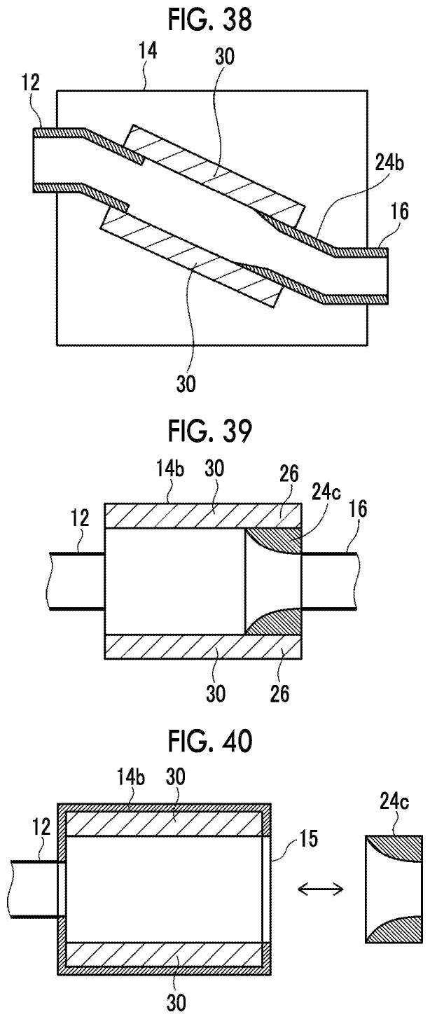

In an example shown in FIG. 38, the opening portion structure 24b is composed of two plate-shaped members and the two plate-shaped members are curved such that the flow path is bent from the direction connecting the inlet-side ventilation pipe 12 and the outlet-side ventilation pipe 16 to each other to the flow direction of the outlet-side ventilation pipe 16. In addition, a distal end side (the inlet-side ventilation pipe 12 side) of each of the plate-shaped members has a region in which the wall thickness gradually decreases.

In addition, an average roughness Ra of an inner surface (a surface on a central axis side) of the opening portion structure is preferably 1 mm or less, more preferably 0.5 mm or less, and still more preferably 0.1 mm or less. By reducing the average roughness Ra of the inner surface of the opening portion structure, it is possible to suppress generation of a wind noise that is caused by a vortex resulting from separation of air flowing on a surface of the opening portion structure.

In addition, in a case where it is assumed that the air passage type silencer according to the embodiment of the present invention is used by being connected to a hose, it is desirable that outer peripheral surfaces of the inlet-side ventilation pipe and the outlet-side ventilation pipe of the air passage type silencer have uneven shapes and/or bellows-like shapes. Wind leakage, sound leakage, sound reflection, or the like can be prevented since the air passage type silencer is firmly tightened in a case of being connected to the hose.

In addition, in the air passage type silencer according to the embodiment of the present invention, a configuration in which the opening portion structure is attachable and detachable with respect to the expansion portion may also be adopted. In this case, it is preferable that the outer shape of a cross section of the opening portion structure that is perpendicular to a central axis of a ventilation pipe is constant regardless of the position in the central axis direction so that the opening portion structure has a shape to be easily inserted into an opening portion formed in the expansion portion.

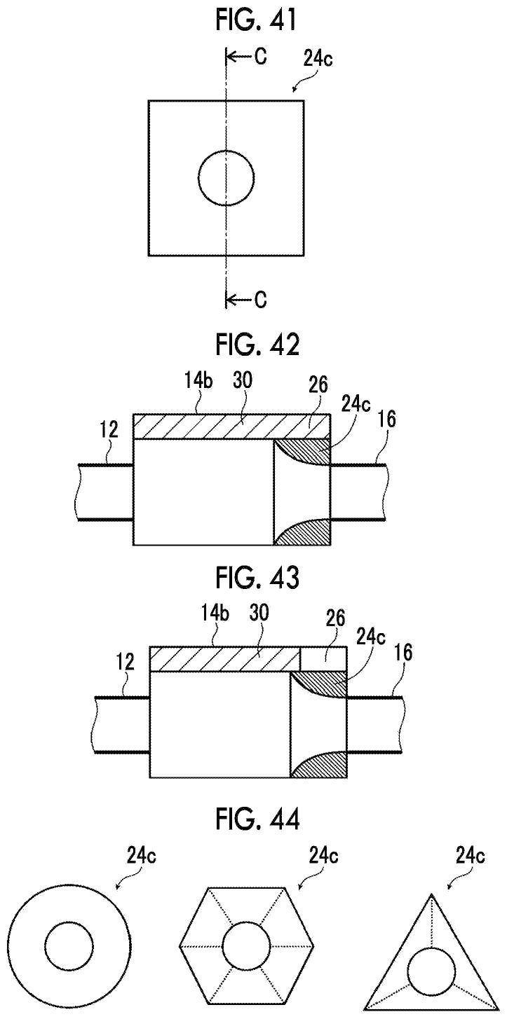

FIG. 39 shows a cross-sectional view conceptually showing another example of the air passage type silencer according to the embodiment of the present invention. FIG. 40 shows a view showing the air passage type silencer in FIG. 39 from which the opening portion structure has been removed. FIG. 41 shows a front view (as seen in the central axis direction) of the opening portion structure that the air passage type silencer shown in FIG. 39 includes. It can be said that an opening portion structure 24c shown in FIG. 40 is a cross-sectional view taken along line C-C of FIG. 41.

An air passage type silencer shown in FIG. 39 includes the tubular inlet-side ventilation pipe 12, an expansion portion 14b connected to one opening edge surface of the inlet-side ventilation pipe 12, the tubular outlet-side ventilation pipe 16 that is connected to an edge surface of the expansion portion 14b on a side opposite to a surface on the inlet-side ventilation pipe 12 side, the opening portion structure 24c, and the porous sound absorbing material 30.

In the air passage type silencer shown in FIG. 39, the inlet-side ventilation pipe 12, the outlet-side ventilation pipe 16, and the porous sound absorbing material 30 have the same configurations as those of the air passage type silencer shown in FIG. 1, and thus the description thereof will be omitted.

In addition, although the outlet-side ventilation pipe 16 is not shown in FIG. 40, the opening portion structure 24c is attachable to and detachable from the outlet-side ventilation pipe 16.

As shown in FIG. 40, the expansion portion 14b of the air passage type silencer shown in FIG. 39 includes an opening portion 15 in a surface of the outlet-side ventilation pipe 16. The opening portion 15 has approximately the same size and shape as the outer shape of the opening portion structure 24c as seen in an axial direction along the central axis of the ventilation pipe (hereinafter, also referred to as a front view). Therefore, the opening portion structure 24c can be inserted and the opening portion structure 24c can be installed in the expansion portion 14b. In the example shown in the drawings, the outer shape of the opening portion structure 24c in the front view is quadrangular. Therefore, the shape of the opening portion 15 of the expansion portion 14b is also quadrangular.

In the example shown in the drawings, the cross-sectional shape of the expansion portion 14b that is perpendicular to the central axis of the ventilation pipe is approximately rectangular and the porous sound absorbing material 30 is disposed along each of four inner surfaces of the expansion portion 14b. Therefore, the cross-sectional shape of a space that is perpendicular to the central axis is approximately rectangular, the space being surrounded by the porous sound absorbing material 30 and serving as an air passage path. The cross-sectional shape of the space serving as the air passage path approximately coincides with the shape of the opening portion 15. That is, the cross-sectional shape of the space serving as the air passage path approximately coincides with the outer shape of the opening portion structure 24c in the front view.

As shown in FIGS. 40 and 41, the outer shape of a cross section of the opening portion structure 24c that is perpendicular to the central axis of the ventilation pipe is constant regardless of the position in the central axis direction, the opening portion structure 24c includes a through-hole that penetrates two surfaces that face each other in the central axis direction, and the through-hole is formed such that the cross-sectional area thereof decreases from one surface side (the inlet-side ventilation pipe 12 side in the case of installation in the expansion portion 14b) toward the other surface side (the outlet-side ventilation pipe 16 side in the case of installation in the expansion portion 14b). In other words, the opening portion structure 24c has an approximately rectangular parallelepiped shape, the through-hole that penetrates the two surfaces facing each other is formed therein, and the through-hole has a shape (a tapered shape) of which the cross-sectional area decreases from one surface toward the other surface.

In the example shown in the drawings, on the one surface side (the inlet-side ventilation pipe 12 side) of the opening portion structure 24c, the cross-sectional shape of the through-hole that is perpendicular to the central axis approximately coincides with the cross-sectional shape of the space that is surrounded by the porous sound absorbing material 30 and that serves as the air passage path. However, on the other surface side (the outlet-side ventilation pipe 16 side) of the opening portion structure 24c, the cross-sectional shape of the through-hole that is perpendicular to the central axis approximately coincides with the cross-sectional shape of the outlet-side ventilation pipe 16.

Since the outer shape of a cross section of the opening portion structure 24c that is perpendicular to the central axis of the ventilation pipe is constant regardless of the position in the central axis direction as described above, the opening portion structure 24c can be made attachable to and detachable from the opening portion 15 provided in the expansion portion 14b. In addition, since the opening portion structure 24c and the expansion portion 14b are provided as separate members, designing each member is facilitated and manufacture through injection molding is facilitated. In addition, since the opening portion structure 24c is provided as a separate member, the opening portion structure 24c can be easily changed. Therefore, it is possible to easily set the resonance frequency in the rear surface space 26 surrounded by the opening portion structure 24c, a side surface of the expansion portion 14b that is on the outlet-side ventilation pipe 16 side, and an inner peripheral surface of the expansion portion 14b, for example.

As with the air passage type silencer shown in FIG. 1 and the like, in the case of the air passage type silencer composed of the expansion portion 14b and the opening portion structure 24c as described above, a space in the expansion portion 14b and the outlet-side ventilation pipe 16 can be smoothly connected to each other by the opening portion structure 24c and a sound absorbing effect can be exerted at a wider band of frequencies since the porous sound absorbing material 30 is disposed in the rear surface space 26. In addition, since the porous sound absorbing material 30 is disposed in the rear surface space 26, wind is less likely to flow into the rear surface space 26. Therefore, a decrease in air passage rate can be suppressed and generation of a wind noise can be suppressed.

Note that in the example shown in FIG. 39, the cross-sectional shape of the expansion portion 14b is rectangular, the cross-sectional shape of the space that is surrounded by the porous sound absorbing material 30 and that serves as the air passage path is rectangular, and the outer shape of the opening portion structure 24c in a front view is rectangular. However, the present invention is not limited thereto and the shapes thereof may be various shapes a circular shape, an oval shape, and polygonal shapes such as a triangular shape and a hexagonal shape. FIG. 44 shows front views of other examples of the opening portion structure 24c.

In addition, the cross-sectional shape of the expansion portion 14b and the outer shape of the opening portion structure 24c in the front view may not be similar to each other.

In addition, in the example shown in FIG. 39, the porous sound absorbing material 30 is disposed over the entire inner peripheral surface of the expansion portion 14b, that is, along each of the four inner surfaces of the rectangular expansion portion 14b. However, the present invention is not limited thereto. For example, as in an example shown in FIG. 42, a configuration in which the porous sound absorbing material 30 is not disposed on one of the four inner surfaces of the rectangular expansion portion 14b and the opening portion structure 24c is attached and detached to be in contact with an inner surface thereof may also be adopted.

In addition, in FIGS. 39 and 42, the porous sound absorbing material 30 is disposed over the entire expansion portion 14b in the direction of the central axis, but the present invention is not limited thereto. The porous sound absorbing material 30 may be disposed at least in an inlet (the opening portion) of the rear surface space 26 and a configuration in which the porous sound absorbing material 30 is not disposed in a portion of the rear surface space 26 as in an example shown in FIG. 43 may also be adopted, for example. It is possible to enhance the effect of resonance generated in the rear surface space 26 by reducing the amount of the porous sound absorbing material 30 disposed in the rear surface space 26.

Examples of the materials of the ventilation pipe, the expansion portion, and the opening portion structure include a metal material, a resin material, a reinforced plastic material, and a carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamide, polyalylate, polyetherimide, polyacetal, polyetheretherketone, polyphenylene sulfide, polysulfone, polyethylene terephthalate, polybutylene terephthalate (PET), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. In addition, examples of the reinforced plastic material include carbon fiber reinforced plastics (CFRP) and glass fiber reinforced plastics (GFRP).

From the viewpoint of weight reduction, easy molding, and the like, it is preferable to use a resin material as the material of the air passage type silencer. In addition, from the viewpoint of low-frequency range sound insulation, it is preferable to use a material having a high stiffness. From the viewpoint of weight reduction and sound insulation, the density of a member constituting the air passage type silencer is preferably 0.5 g/cm³ to 2.5 g/cm³.

The porous sound absorbing material is not particularly limited, and a sound absorbing material publicly known in the related art can be used as appropriate. For example, various known sound absorbing materials such as a foaming body, a foaming material (foaming urethane foam (for example, CALMFLEX F manufactured by INOAC CORPORATION, urethane foam manufactured by Hikari Co., Ltd., and the like), flexible urethane foam, a ceramic particle sintered material, phenol foam, melamine foam, a polyamide foam, and the like), a nonwoven fabric sound absorbing material (a microfiber nonwoven fabric (for example, Thinsulate manufactured by 3M Company and the like), a polyester nonwoven fabric (for example, White Kyuon manufactured by TOKYO Bouon and QonPET manufactured by Bridgestone KBG Co., Ltd. and such products are provided even in the form of a two-layer configuration with a high-density thin surface nonwoven fabric and a low-density rear surface nonwoven fabric), a plastic nonwoven fabric such as an acrylic fiber nonwoven fabric, a natural fiber nonwoven fabric such as wool and felt, a metal nonwoven fabric, a glass nonwoven fabric, and the like), and a material including a minute amount of air (glass wool, rock wool, and a nanofiber-based fiber sound absorbing material (silica nanofiber and acrylic nanofiber (for example, XAI manufactured by Mitsubishi Chemical Corporation))) can be used.

It is desirable that these materials are non-flammable, flame-retardant, and self-extinguishing. In addition, it is also desirable that the entire air passage type silencer is non-flammable, flame-retardant, and self-extinguishing.

### EXAMPLES

Hereinafter, the present invention will be more specifically described based on examples. Materials, used amounts, ratios, treatment contents, treatment procedures, and the like described in the following examples can be appropriately changed without departing from the spirit of the present invention. Therefore, the scope of the present invention should not be construed as being limited to Examples shown below.

### Comparative Example 1

Acrylic plates were combined to form a rectangular parallelepiped tubular member having a length of 200 mm, the tubular member being provided with an opening having a size of 80 mm×80 mm. Two acrylic plate members, each of which has the same size as an opening surface of the tubular member and includes a central hole having a diameter of 28 mm, were prepared, the plate members were closely attached to both opening surfaces of the tubular member, and the tubular member was acoustically closed by using tape to manufacture an expansion portion. A cylindrical inlet-side ventilation pipe and a cylindrical outlet-side ventilation pipe having an inner diameter of 28 mm and a length of 50 mm were prepared and were connected with the centers of holes in edge surfaces of the expansion portion being aligned with the center of a cylinder. In this manner, an air passage type silencer 100a including an inlet-side ventilation pipe 112, an expansion portion 114, and an outlet-side ventilation pipe 116 as shown in FIG. 17 was manufactured. Note that the ventilation pipes were formed of ABS resin by using a 3D printer (manufactured by XYZ printing, Inc.). The thickness of the ABS resin was 3 mm. Note that an interior wall was polished.

### Comparative Example 2

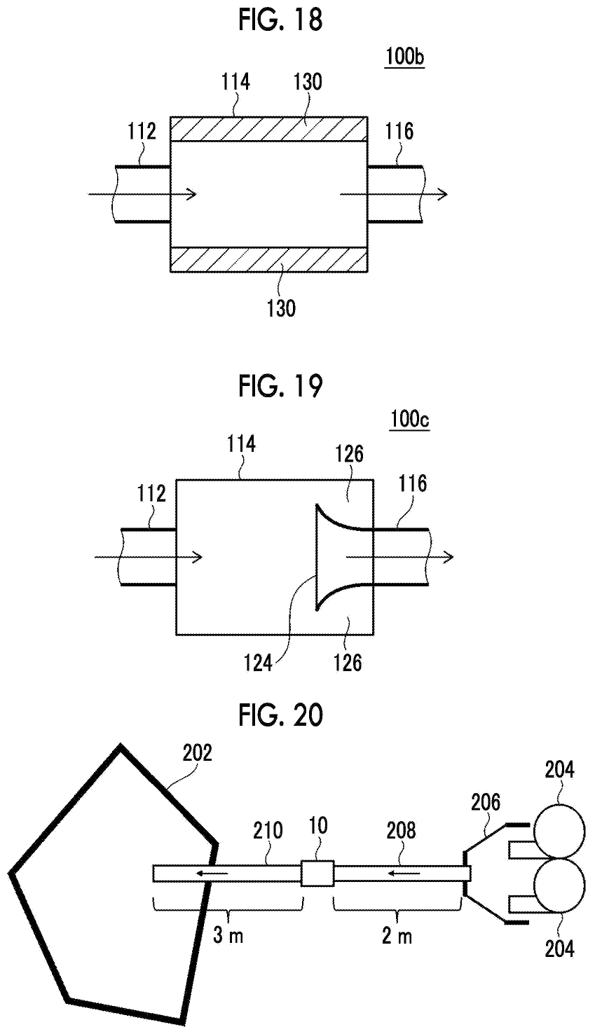

An air passage type silencer 100b as shown in FIG. 18 was manufactured in the same manner as in Comparative Example 1 except that a porous sound absorbing material (QonPET manufactured by Bridgestone KBG Co., Ltd.) 130 having a thickness of 15 mm was disposed along an inner peripheral surface of the expansion portion 114.

### Comparative Example 3

A horn-shaped cylinder (having an inner diameter of 28 mm on a narrow side, including an opening having a size of 50 mm×50 mm on a wide side, having a length of 45 mm in the flow path direction, having a thickness of 1.5 mm, and formed of ABS) of which both sides were open was manufactured by using a 3D printer. An increase in horn diameter was exponential. An air passage type silencer 100c as shown in FIG. 19 was manufactured in the same manner as in Comparative Example 1 except that the horn-shaped cylinder was attached, as an opening portion structure 124, to the connection portion between the expansion portion 114 and the outlet-side ventilation pipe 116 with an opening on the narrow side (a side of a diameter of 28 mm) being aligned therewith. A rear surface space 126 was formed between a peripheral surface and side surfaces of the expansion portion 114 and the opening portion structure 124.

### Example 1

The air passage type silencer 10 was manufactured in the same manner as in Comparative Example 1 except that the porous sound absorbing material (QonPET manufactured by Bridgestone KBG Co., Ltd.) 30 having a thickness of 15 mm was disposed along the inner peripheral surface of the expansion portion 14 and the opening portion structure 24 that is the same as the opening portion structure manufactured in Comparative Example 3 was attached to the connection portion between the expansion portion 14 and the outlet-side ventilation pipe 16 with an opening on a narrow side (a side of a diameter of 28 mm) being aligned therewith. The rear surface space 26 was formed between a peripheral surface and side surfaces of the expansion portion 14 and the opening portion structure 24. The porous sound absorbing material 30 was disposed in the opening portion of the rear surface space 26.

### [Evaluation]

The sound attenuation performance at the time of passage of air of the manufactured air passage type silencer was measured by using a measurement device as shown in FIG. 20.

As shown in FIG. 20, an inlet-side hose (transparent vinyl hose manufactured by Chubu Vinyl Industry CO., LTD. (the inner diameter thereof is 28 mm)) 208 having a length of 2 m was connected to the inlet-side ventilation pipe of the air passage type silencer and two blower fans (San Ace DC blowers manufactured by SANYO DENKI CO., LTD. (model number: 9BMC24P2G001)) 204 were disposed on a distal end side of the inlet-side hose 208. A rectifying plate 206 that was formed such that air sent from the blower fans 204 driven with a voltage of 24 V flows into the inlet-side hose 208 was connected. In addition, an outlet-side hose 210 having a length of 3 m was connected to the outlet-side ventilation pipe, and a distal end of the outlet-side hose 210 was disposed in a reverberation chamber 202. Four measurement microphones were installed in the reverberation chamber 202.

The two blower fans 204 were driven to send air, measurement was carried out with the four measurement microphones, a frequency range of 62.5 Hz to 5000 Hz was analyzed in an one-third octave band, and a sound pressure level (the average value of the four measurement microphones) was obtained.

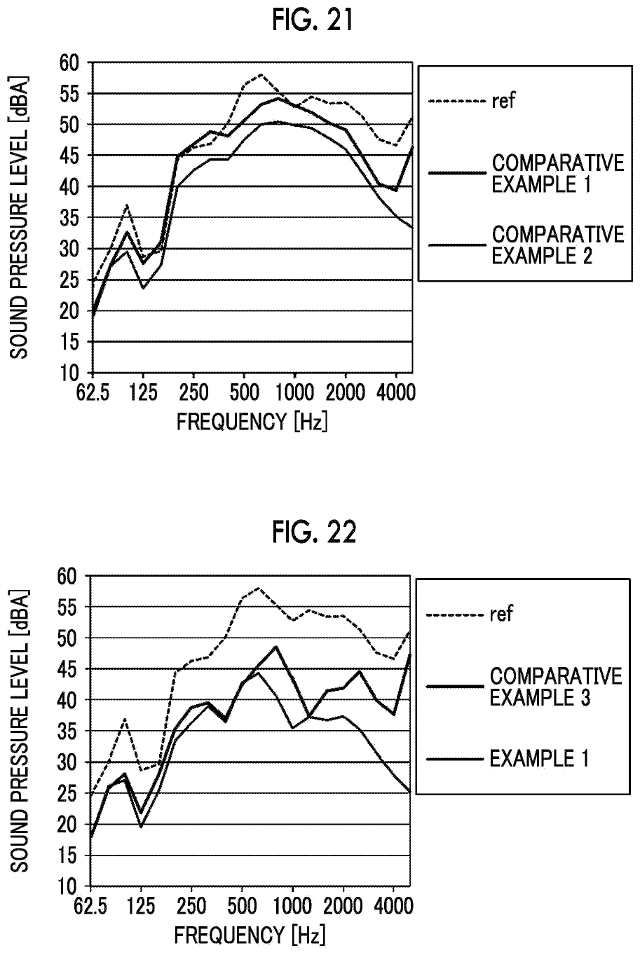

In addition, the sound pressure level was obtained by using a state where the inlet-side hose 208 and the outlet-side hose 210 were directly connected to each other without the air passage type silencer as a reference (ref). The results of sound pressure level measurement in Example, Comparative Examples, and the reference are shown in graphs of FIGS. 21 and 22.

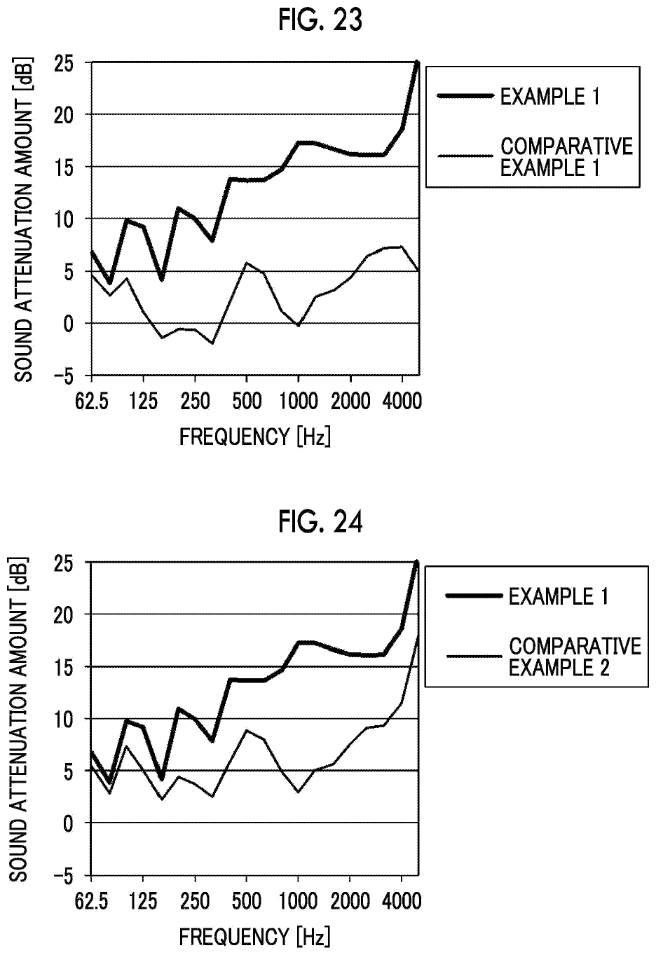

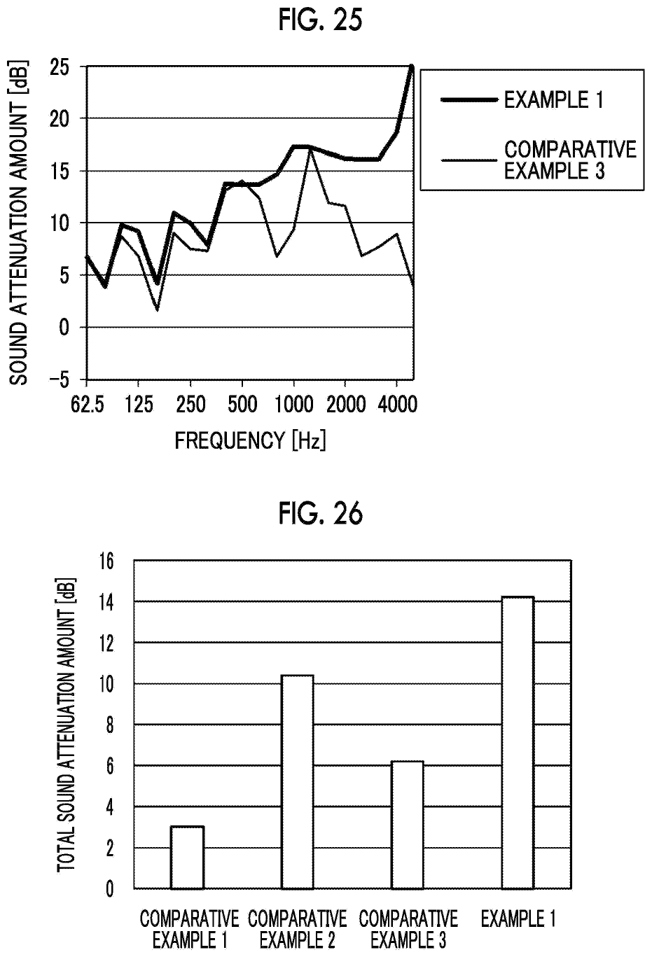

In addition, a difference in sound pressure level between Example and the reference and differences in sound pressure level between Comparative Examples and the reference were obtained as sound attenuation amounts. The results of comparison between Example 1 and Comparative Examples 1 to 3 are shown in FIGS. 23, 24, and 25, respectively.

In addition, the results of obtainment of total sound attenuation amounts in the frequency range of 62.5 Hz to 5000 Hz in Example 1 and Comparative Examples 1 to 3 are shown in FIG. 26.

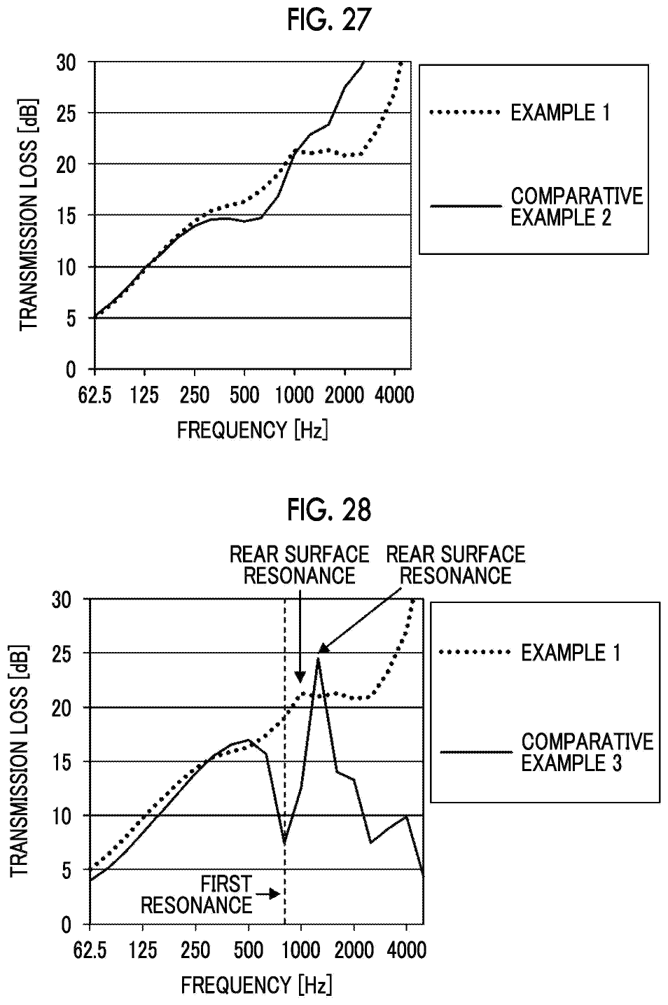

Next, transmission loss during a non-air-passage time was evaluated for each air passage type silencer by using a vertical incidence transmission loss measurement method specified in ASTM E2611-09. The results of comparison between Example 1 and Comparative Examples 2 and 3 are shown in FIGS. 27 and 28, respectively.

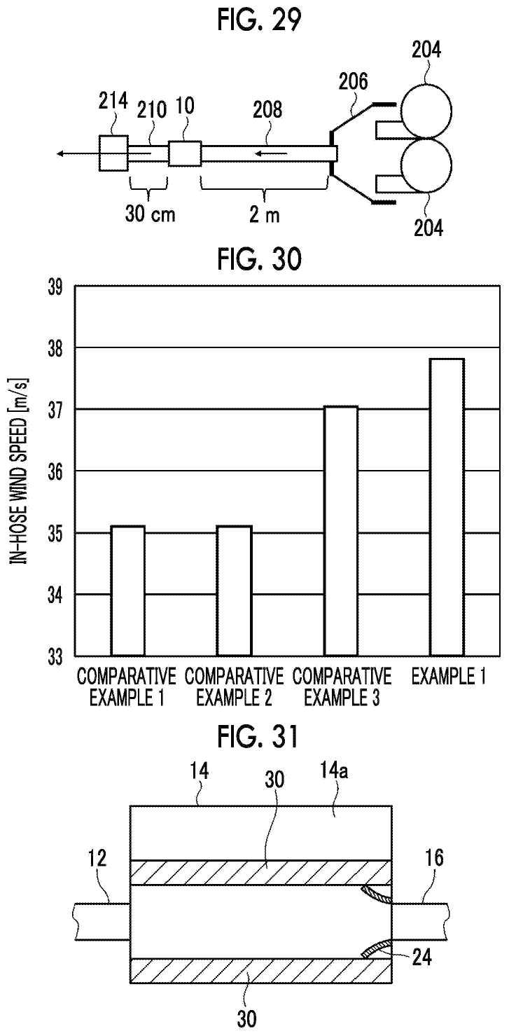

Next, an air passage rate (wind speed) was measured by using a measurement device as shown in FIG. 29.

As shown in FIG. 29, as with the measurement device shown in FIG. 20, the inlet-side hose 208, the rectifying plate 206, and the two blower fans 204 were disposed on the inlet-side ventilation pipe side of the air passage type silencer. An outlet-side hose 212 having a length of 30 cm was connected to the outlet-side ventilation pipe of the air passage type silencer, and a wind speed meter (a wind speed and wind flow volume meter TM-413 manufactured by TENMARS ELECTRONICS CO., LTD.) 214 was connected to a distal end of the outlet-side hose 212.

The two blower fans 204 were driven to send air, and a wind speed passing through the air passage type silencer was measured by using the wind speed meter 214. With the wind speed measured by the wind speed meter, an in-hose wind speed was obtained based on the following expression. The result is shown in FIG. 30.

(in-Hose Wind Speed)=(Wind Speed of Wind Speed Meter)×(Air Reception Area of Wind speed meter)/(cross-sectional area of hose)

It can be found from FIGS. 23, 24, 25, and 26 that sound attenuation performance in Example of the present invention is high in comparison with Comparative Examples. It can be found that a frequency band in which a sound attenuation amount decreases is present within a range of 700 Hz to 1200 Hz and a favorable sound attenuation performance cannot be achieved in a low-frequency range in the case of Comparative Example 3 in which the opening portion structure is provided although there is no difference in sound attenuation amount between Comparative Example 3 and Example 1 at a peak around 1200 Hz.

In addition, it can be found from FIG. 27 that acoustic (in a case where there is no wind) sound attenuation performance around 500 Hz in Example 1 is improved since the opening portion structure is provided. In addition, it can be found from FIG. 28 that the sound attenuation performance is deteriorated at first resonance (850 Hz) in Comparative Example 3 but a frequency range of rear surface resonance can be widened and improvement in sound attenuation performance in such a frequency band and improvement in total sound attenuation amount can be achieved in Example 1 since the porous sound absorbing material is provided.

In addition, it can be found from FIG. 30 that air passage performance in Example of the present invention is high in comparison with Comparative Examples.

As understood from the above results, the effect of the present invention is obvious.

### EXPLANATION OF REFERENCES

10, 100a to 100c: air passage type silencer
12, 112: inlet-side ventilation pipe
14, 14b, 114: expansion portion
16, 116: outlet-side ventilation pipe
24, 24b, 24c, 124: opening portion structure
26, 126: rear surface space
30, 130: porous sound absorbing material
32: bend ventilation pipe

What is claimed is:

1. An air passage type silencer comprising:
an inlet-side ventilation pipe;
an expansion portion that communicates with the inlet-side ventilation pipe and of which a cross-sectional area is larger than a cross-sectional area of the inlet-side ventilation pipe;
an outlet-side ventilation pipe that communicates with the expansion portion and of which a cross-sectional area is smaller than a cross-sectional area of the expansion portion;
an opening portion structure of which a cross-sectional area gradually decreases from an inside of the expansion portion toward a connection portion between the expansion portion and the outlet-side ventilation pipe;
a rear surface space that is surrounded by the opening portion structure, a side surface of the expansion portion that is on an outlet-side ventilation pipe side, and a peripheral surface of the expansion portion; and
a porous sound absorbing material that is disposed at least in an opening portion of the rear surface space.

2. The air passage type silencer according to claim 1,
wherein f₁×(1-0.2)<F<fc is satisfied, where F is a resonance frequency in the rear surface space in a state where the porous sound absorbing material is not disposed, f₁ is a first resonance frequency of the air passage type silencer in the state where the porous sound absorbing material is not disposed, and fc is a cutoff frequency determined by a cross-sectional area of an opening of the outlet-side ventilation pipe.

3. The air passage type silencer according to claim 1,
wherein a cross-sectional shape of the opening portion structure that is perpendicular to a central axis of the outlet-side ventilation pipe is a quadrangular shape,
a distance between one pair of sides facing each other gradually decreases from the inside of the expansion portion toward the connection portion between the expansion portion and the outlet-side ventilation pipe, and
a distance between the other pair of sides facing each other is constant.

4. The air passage type silencer according to claim 1,
wherein the opening portion structure has a structure in which two plate-shaped members face each other and a distance between the two plate-shaped members gradually decreases from the inside of the expansion portion toward the connection portion between the expansion portion and the outlet-side ventilation pipe.

5. The air passage type silencer according to claim 1,
wherein a cross-sectional shape of the expansion portion that is perpendicular to a central axis of the outlet-side ventilation pipe is a rectangular shape.

6. The air passage type silencer according to claim 1,
wherein a central axis of the outlet-side ventilation pipe and a central axis of the inlet-side ventilation pipe are on one straight line.

7. The air passage type silencer according to claim 1,
wherein the porous sound absorbing material is disposed on a region from a side surface of the expansion portion that is on an inlet-side ventilation pipe side to a side surface on the outlet-side ventilation pipe side.

8. The air passage type silencer according to claim 1,
wherein a central axis of the outlet-side ventilation pipe is offset from a center of the side surface of the expansion portion.

9. The air passage type silencer according to claim 1,
wherein the opening portion structure includes a region in which a wall thickness decreases toward an inlet-side ventilation pipe side.

10. The air passage type silencer according to claim 1,
wherein the opening portion structure is attachable and detachable with respect to the expansion portion.

11. The air passage type silencer according to claim 2,
wherein a cross-sectional shape of the opening portion structure that is perpendicular to a central axis of the outlet-side ventilation pipe is a quadrangular shape,
a distance between one pair of sides facing each other gradually decreases from the inside of the expansion portion toward the connection portion between the expansion portion and the outlet-side ventilation pipe, and
a distance between the other pair of sides facing each other is constant.

12. The air passage type silencer according to claim 2,
wherein the opening portion structure has a structure in which two plate-shaped members face each other and a distance between the two plate-shaped members gradually decreases from the inside of the expansion portion toward the connection portion between the expansion portion and the outlet-side ventilation pipe.

13. The air passage type silencer according to claim 2,
wherein a cross-sectional shape of the expansion portion that is perpendicular to a central axis of the outlet-side ventilation pipe is a rectangular shape.

14. The air passage type silencer according to claim 2,
wherein a central axis of the outlet-side ventilation pipe and a central axis of the inlet-side ventilation pipe are on one straight line.

15. The air passage type silencer according to claim 2,
wherein the porous sound absorbing material is disposed on a region from a side surface of the expansion portion that is on an inlet-side ventilation pipe side to a side surface on the outlet-side ventilation pipe side.

16. The air passage type silencer according to claim 2,
wherein a central axis of the outlet-side ventilation pipe is offset from a center of the side surface of the expansion portion.

17. The air passage type silencer according to claim 2,
wherein the opening portion structure includes a region in which a wall thickness decreases toward an inlet-side ventilation pipe side.

18. The air passage type silencer according to claim 2,
wherein the opening portion structure is attachable and detachable with respect to the expansion portion.

19. The air passage type silencer according to claim 3,
wherein a cross-sectional shape of the expansion portion that is perpendicular to a central axis of the outlet-side ventilation pipe is a rectangular shape.

20. The air passage type silencer according to claim 3,
wherein a central axis of the outlet-side ventilation pipe and a central axis of the inlet-side ventilation pipe are on one straight line.
